(19) United States
(12) Patent Application Publication
(10) Pub. No.: US 2002/0042834 A1
(43) Pub. Date: Apr. 11, 2002

(54) Network music and video distribution and synchronization system

(75) Inventors: James A. Kremens, Brooklyn, NY (US); John R. Jones, Dobbs Ferry, NY (US)

Correspondence Address: Kevin J. Heinl, Brooks & Kushman P.C., 22nd Floor, 1000 Town Center, Southfield, MI, 48075-1351, US

(73) Assignee: ReelScore, LLC, New York, NY (US)

(21) Appl. No.: 09/973,892

(22) Filed: Oct. 10, 2001

Related U.S. Application Data
(60) Provisional application No. 60/238,938, filed on Oct. 10, 2000.

(51) Int. Cl. G06F 15/16

(52) U.S. Cl. 709/231; 709/245

(57) ABSTRACT

A multimedia system and project management tool are provided for locating and auditioning audio files and video files in synchronization. Distributed source computers provide multimedia files to a multimedia warehouse comprising a network server and a database. The multimedia files are then accessed by a multimedia sampling computer for playback.

### CROSS-REFERENCE TO RELATED APPLICATIONS

This application claims the benefit of U.S. provisional application Serial No. 60/238,938 filed Oct. 10, 2000.

### TECHNICAL FIELD

The present invention relates to the distribution of musical and video works over a network that permits selection of music and video from a searchable database. The invention facilitates synchronization and evaluation of multiple audio files synchronized with video files.

### BACKGROUND ART

Commercial movies, independent films, video productions and television commercials are currently produced by a creative team composed of editors, composers, directors and producers who audition music while viewing film scenes. Video editing software such as Avid Media Composer and Apple Final Cut Pro are used to synchronize music to video files.

Many composers and music publishers produce music and are interested in providing their music to filmmakers for inclusion in audiovisual works. Recently, some companies have begun distributing music files over the Internet and some companies have also begun to offer a searchable online library of music. With such services, an editor may search the online music library and select a musical work to audition for inclusion in a film scene. The music to be auditioned must be loaded into the editing machine before it can be synchronized with the picture. The scoring process may take several days or weeks to complete depending upon the amount of music required, the difficulty in acquiring or perfecting that music, and the number of iterations performed.

Once the music to be used has been selected, the filmmaker must acquire rights to use the music from the composer or publisher of the music. Some music publishers, such as music libraries of publishing divisions of record companies, have preset licensing rates based upon the use of the music, audience size, and other factors.

Internet based music purchasing services are available including “licensemusic.com” and “beatnik.com” but neither of these sources offers a music editor the ability to readily synchronize music to film.

While Internet delivery of audio and video files and editing software is known, there is currently no convenient system that offers multiple audio file delivery, preview, purchase and synchronization.

There is a need for a comprehensive music editing system that facilitates browsing of multiple musical selections identified through a searchable database, the synchronization of those selections to film or video, and the procurement of legal rights to perform those selections in a film.

### DISCLOSURE OF INVENTION

According to one aspect of the present invention, a network-based system for centrally sampling distributed multimedia is provided. The system comprises a plurality of distributed multimedia source computers and a multimedia warehouse, or library, configured to receive and archive multimedia files uploaded from the plural distributed multimedia source computers. At least one multimedia sampling computer is configured to download one or more multimedia files archived in the multimedia warehouse and play the downloaded multimedia files in synchronization with a project file.

According to other aspects of the invention, the multimedia warehouse may comprise a network server computer system in communication with a database. The multimedia files may consist of audio files, video files, combined audio and video files, and picture files. The project file may also be an audio file, video file, combined audio and video file, or a picture file. The multimedia sampling computer may be configured to search the multimedia warehouse for multimedia files that best match user-defined search criteria. The user-defined search criteria may comprise search criteria including file type, file format, composition name, company name, composer name, project name, tempo and description. The tempo criteria may be defined by a tap tempo calculator peripheral device that is connected to the multimedia sampling computer.

Other aspects of the present invention are that the multimedia sampling computer may be configured to edit playback attributes of the downloaded multimedia files. The multimedia source computer, multimedia warehouse, and multimedia sampling computers may be configured to host purchasing or licensing transactions for multimedia files. The distributed multimedia source computers, multimedia warehouse, and multimedia sampling computers may also be configured to host on-line communications between users of the multimedia source computers and the multimedia sampling computers. The network based system may also be configured to monitor version control for multimedia file revisions.

The network based method of the present invention in addition to receiving multimedia files from a plurality of distributed multimedia providers into an on-line media warehouse and providing multimedia files within the on-line multimedia warehouse may also comprise selling or licensing the downloaded multimedia file to the multimedia consumer.

According to another aspect of the present invention, a computer-readable storage medium is provided that contains computer executable codes for instructing one or more computers to receive input defining multimedia file search criteria. One or more databases may be searched for multimedia files that best match the search criteria. The computers may be instructed to present output containing selectable listings of multimedia files that best match the search criteria. The computers may also receive user input selecting one or more of the multimedia files and playing the selected multimedia files in synchronization with a project file.

According to one embodiment of the invention, an audio and video synchronization system is provided that allows a database to be accessed either locally or over a network. This database is searched, based upon search criteria, to develop a list of musical works that may be auditioned in synchronization with the user's video files. By simply selecting a musical file from a list, the file may be played in synchronization with the user's video clip. The music and video synchronization system allows a user to synchronize localized or web based audio with localized or web based video. A single interface is used to search and download selected audio and video files from various locations so that they may be previewed prior to licensing. The invention permits buyers of video and music for audiovisual works to obtain video and music on demand and to audition one or more music selections in synchronization with video quickly and efficiently.

Another embodiment of the invention allows filmmakers, advertising agencies, movie studios, television production companies and other content producers to collaborate with vendors of video (film directors, production companies and film editors) and audio (composers, music publishers and custom music houses) via a web-based project management tool. The invention allows content producers to initiate projects and grant vendors access to those projects via an e-mail invitation system. Vendors may upload video and audio files into projects for which they have received an e-mail invitation.

According to another embodiment of the invention, a thin-client desktop application (media player) is provided for project based media review. Content producers may use the project-oriented media player to retrieve video and audio files from an online database grouped by project, and play multiple files from that project file set simultaneously.

Additionally, the invention may be used by film editors and composers to post their works to a server in order to collaborate with filmmakers, advertising agencies, movie studios, television production companies and other content producers. The invention allows content producers to instantly review music submissions and revisions in synch video submissions and revisions from multiple locations and to communicate requested changes to film editors and composers via an instant messaging tool or by video conferencing through the same media player on the desktop. Point-to-point videoconferencing (without going through a central server) may be incorporated that allows video and audio connection between any users involved in a project. Any user in the project can directly conference to any other user in the project or “broadcast” to all other members of the project. Purchasers may work with multiple film editors and composers at the same time over a network via a single interface.

According to another aspect of the invention, a local server is employed to provide users of the invention with instantaneous access to video and audio files originally uploaded to a web-based server. The local server queries the web server at regular intervals, retrieving any new video or audio files that have been posted there and transferring them to the local server. Users of the desktop media player then access these files over their local network, eliminating the delay associated with file download over the Internet.

According to another embodiment of the invention, an online music database is provided that includes search criteria including file type, file format, composition name, company name, composer name, project name, tempo and description. The database may also be searched by means of a tap tempo calculator by which a user may tap on an input device, such as a mouse, that allows a system to calculate the user's desired tempo in beats per minute. This data can then be used as one of the search criteria.

The invention may also offer composers and publishers of music a mechanism for promoting musical works to buyers of music if the musical works match specified search criteria. The invention also allows composers and publishers of music to submit musical works over a network to music buyers upon request for purposes of preview in synchronization with the music buyer's film project. The invention may also permit viewing a visual work as it is being recorded, or filmed, by authorized users.

These and other objects and advantages of the present invention will become apparent in view of the attached drawings and in light of the following detailed description of the invention.

### BRIEF DESCRIPTION OF DRAWINGS

FIG. 1 is a flowchart of the project management process;

FIG. 2 is a flowchart showing an example of how a composer or publisher can make musical works available to a service provider and receive compensation for use of the musical works; and

FIG. 3 is a flowchart showing how a filmmaker or editor may work with a service provider to search musical works, select audio files from a search results list, obtain the audio file for review, edit and/or select an audio file and complete the process by licensing the musical work through the service provider.

### BEST MODE FOR CARRYING OUT THE INVENTION

According to the present invention, a project management environment is provided wherein producers of content such as filmmakers, advertising agencies, movie studios and television production companies can collaborate with vendors of video (film directors, production companies and film editors) and audio (composers, music publishers and custom music houses) via a single-interface software project management tool. By connecting producers of content with video and music vendors through single project-oriented, collaborative interface, an efficient methodology for managing audio-video production projects is provided. Another by-product of the project management environment is that an efficient film music marketplace is created. Buyers of music have access over a network such as the Internet to the works of various music sellers for the purposes of preview and purchase.

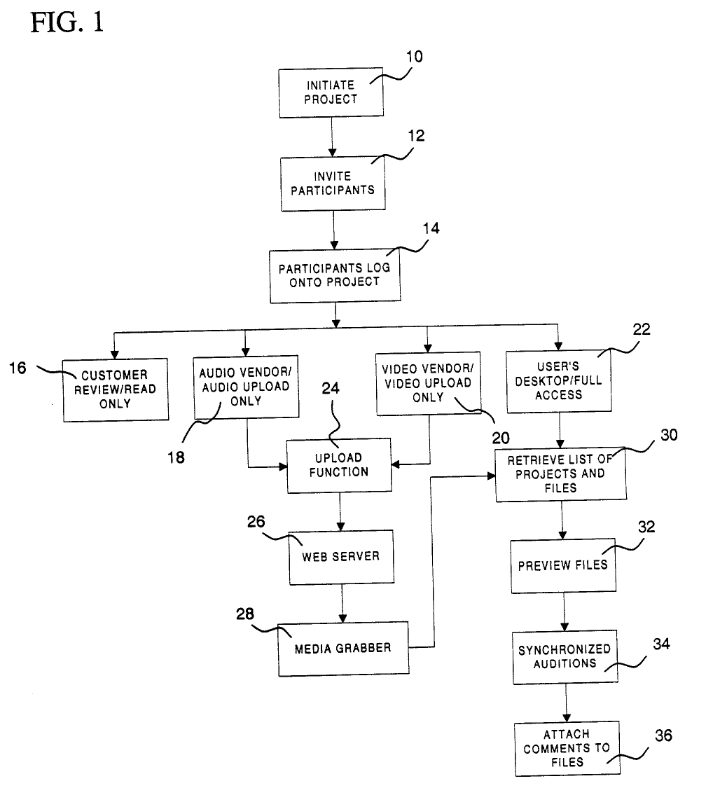

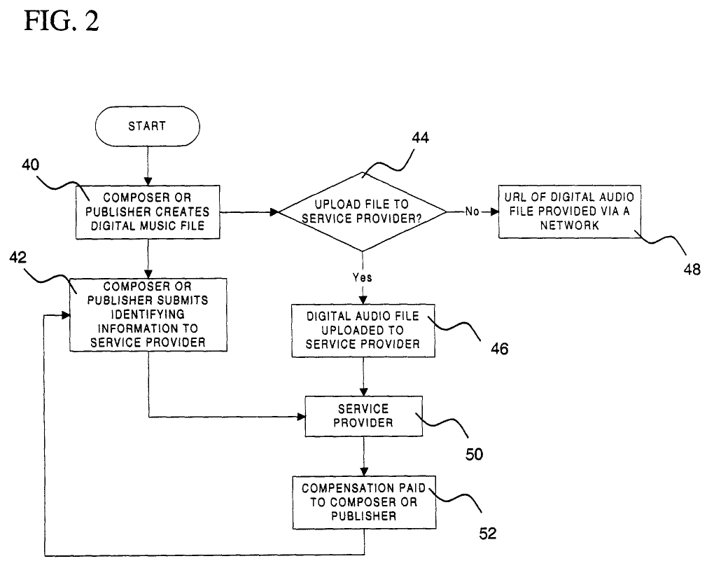

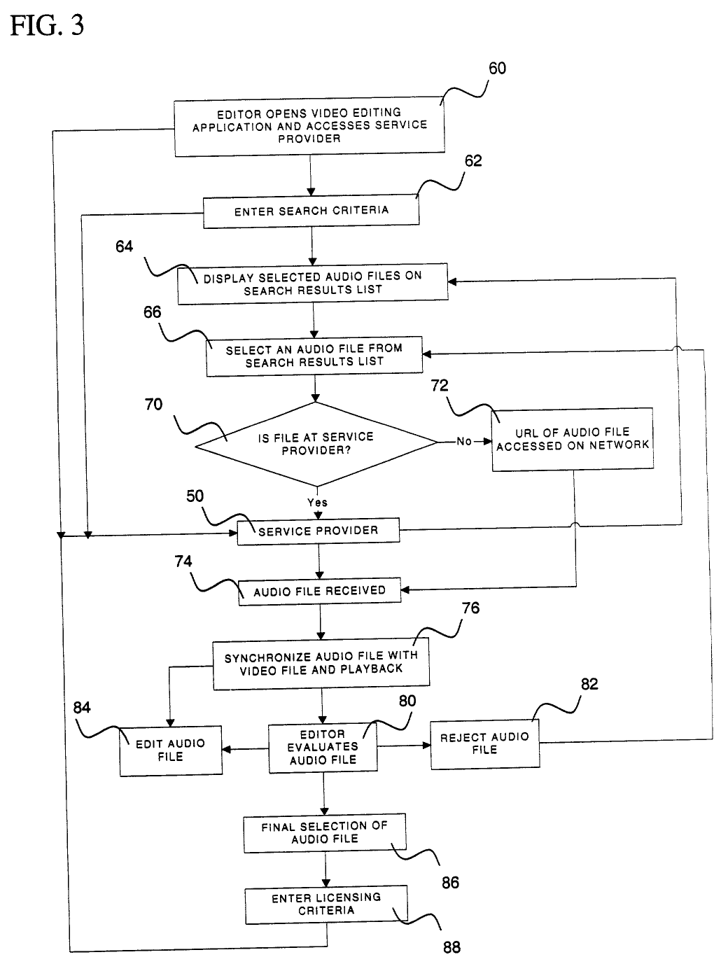

The system of the present invention will be described with reference to FIGS. 1, 2 and 3 wherein FIG. 1 diagrams the project management process steps as accomplished through the software interface. FIG. 2 diagrams the transactions on the seller's side of the film music marketplace. FIG. 3 diagrams transactions on the buyer's side of the film music marketplace.

Referring now to FIG. 1, the description of the system of the present invention begins with an ad agency user or other content provider initiating a project as defined by the software interface at 10. (Initiation of the project creates an area on the web server and corresponding database entries unique to that project). User invites participants to the project via an e-mail invitation system at 12. The system allows user to specify access level of project participant based on participant's customary “role” in the project.

Each of the access levels is described more specifically below. Access levels range from least restrictive to most restrictive. “View Only” access allows participants only to view project files and offers no upload privileges; “Upload Only” access allows participants only to access project files they uploaded themselves; “Audio Upload” access allows participants to access only audio files they uploaded themselves, but all video files; “Video Upload” access allows participants to access only video files they uploaded themselves, but all audio files; and “Full Access” allows participants to access all project files.

Once access level has been determined, user enters e-mail address of a participant and sends e-mail invitation at 12. The participant clicks link in the e-mail invitation at 14, which leads them to web interface where they create their own user name and password. They are then granted access to the project. If they are a customer, they are allowed view only access at 16. If they are an audio vendor, they proceed to audio upload at 18. If they are a video vendor, they proceed to video upload at 20. If they are the advertising agency responsible for the project, they will be allowed full access at 22. Via web interface, users locate media that they have access to and that they wish to upload on their local network by clicking “upload” at 24. Media is copied from user's location to web at 26.

A “media grabber” server, which resides at user's location (ad agency, content provider, etc.) queries web database at periodic intervals (every 3 minutes) to determine if any new files have been uploaded by vendors to a host web database. If so, the media grabber copies files from web to media grabber at 28.

User opens a thin client desktop application player to log into project for purposes of review and approval. Application retrieves list of projects and files from web database at 30. User selects project media files they wish to preview at 32. If user is at agency location, application copies project media files from the media grabber server to the user's desktop over a local network, eliminating delay associated with Internet download. User auditions selected audio files in synchronization with selected video file at 34. User attaches comments to selected files at 36. Comments can be viewed by all others that share access to that file.

The project management aspects of the invention as described above facilitate the work of content providers working with video and audio vendors. With regard to audio, the system as described above is useful for collaboration with vendors of custom audio and music.

FIG. 2 describes the means by which the invention permits access to libraries of published music in addition to the custom music already described. Referring now to FIG. 2, the description of the system of the present invention begins with a composer or music publisher creating a digital music file at 40. A composer or publisher also submits identifying information to the database at 42 that provides useful information for searching for digital music files. Some or all of the following information may be used to describe the digital audio file, file type, file format, composition name, company name, composer name, project name, tempo, and description. Any of the above criteria, or other criteria, can be assembled into a database and may be used by the database search application in conducting digital audio file database searches.

Each criterion is described more specifically below. File type refers to the classification of digital audio files by type. Potential types of files include, but are not limited to, music, sound effects, and speech. The file format criterion refers to the classification of digital audio files by format. Formats include, but are not limited to, MP3, rmf, Liquid Audio, Real Audio, QuickTime Audio and Sound Designer II files. The composition (or file) name criterion refers to the categorization of musical compositions and other digital audio files by their name. The company name criterion refers to the owner of the digital audio file and generally will correspond to the name of the copyright owner. The composer name criterion refers to the name of the composer or creator of the digital audio file. The project name criterion is applicable when a composer or publisher has been commissioned by a music purchaser to create a custom digital audio file for a specific project. If so, a project name may be assigned to the digital audio file. The tempo criterion refers to the tempo of a digital audio file that may be used for searching. The tempo criterion may be established by using a mouse or other input device as a tap tempo calculator. The tap tempo calculator calculates the tempo received from the input device in beats per minute to permit specification of a tempo range for the digital audio file. The description criterion is a written description of the digital audio file prepared by the composer or publisher.

After a digital music file is created, the composer or publisher may decide at 44 if they wish to up-load their digital music file to the service provider. If the composer or publisher agrees to place their digital audio file on the service provider's server, the digital audio file is uploaded at 46 to the service provider site 50. When the file is uploaded, entries are made in the database referring to this file, its corresponding criteria and project, if applicable. Digital audio format and compression options include, but are not limited to, MP3, rmf, Liquid Audio, Real Audio, QuickTime Audio and Sound Designer II files. Other digital audio format and compression options are continuing to be developed. Within in each file format, multiple data compression rates are available. A service provider would not be limited to any one format, standard or compression rate, but would be enabled to incorporate future developments so that it may continue to offer state-of-the-art services.

Referring now to FIG. 3, a music purchaser or editor opens the application and accesses the service provider at 60. The editor from within the application accesses the service provider 50. The editor enters search criteria at 62 including, but not limited to, search criteria such as file type, file format, composition name, company name, composer name, project name, tempo, and description. The service provider receives the search criteria at 50.

If a search by tempo is employed, a tap tempo calculator receives the tempo from a mouse or other input device that is measured by the tap tempo calculator to provide a tempo calculation in beats per minute. If a search by description is employed, the database search application searches the database of digital audio file descriptions. Regardless of the search criteria entered, the service provider 50 provides information to the editor by displaying selected audio files on a search results list at 64. The editor then may select an audio file from the search results list at 66.

Upon selection of an audio file from the search results list, the system determines at 70 whether the file is at the service provider. If the file is at the service provider, the service provider is contacted and the audio file is downloaded from the service provider to the editor's computer or network. If the file is determined at 70 not to be at the service provider, the URL of the audio file is accessed and the audio file is downloaded to the editor. In either event, the audio file is received at 74. The editor may then trigger playback of the audio file with a video file at 76. When enough of the audio file has been retrieved by the editor's system in a buffer, the application synchronizes the incoming digital audio file with the user's video. The audio file is played synchronously in time with the video file.

The video and audio files can be stored either locally or on a network. If the video is local, then the audio may be downloaded or streamed. If the video is also on a network, then both the video and audio may be streamed synchronously to the application. If the video is on a network, the audio may be local. If so, when enough of the video file has been retrieved to the user's system in the user's system buffer, the application will synchronize the incoming video file with the local audio file.

The editor evaluates the audio file at 80. The editor may reject the audio file at 82 and return to the search results list at 66 to select another audio file for evaluation. If so, the system continues as previously described. After the editor evaluates the audio file at 80, they may elect to edit the audio file at 84 and then synchronize the edited audio file with the video file and playback again at 76 to reevaluate at 80.

Editing functions may be automated by the application. The step of editing audio files may include any of the following options or others that are available in the desktop editing application.

One example of an editing function includes changing synchronization wherein the editor can shift the digital audio file earlier or later in time in relation to the video file. This is accomplished by “dragging” the audio file waveform earlier or later in relation to the video file as depicted on a time line. Movement of the audio file can occur in realtime while video is playing without causing interruption of video playback and with continuous audio feedback indicating location of audio file as it is moved.

The editor may also change the start point of video playback by placing a marker in the time line or waveform of the digital audio file. The marker instructs the application to begin playback of the digital video file at the specified moment in the file.

Another editing function that may be performed is recombining musical selections. An editor can deconstruct musical selections from various sources. The editor may keep certain elements of a musical piece while discarding others. Editors can then combine those elements with elements of other pieces that they have deconstructed from other musical sources. The service provider 50 may stream these elements to the editor from different sources bringing them to the desktop of the editor where they can be further edited.

Editing of audio files at 84 may include re-mixing by the editor who can change the audio playback levels of audio files and/or various elements of those files. It may also include changing tempo wherein the editor can change the tempo of an audio file and/or various elements of those files. Files can be stretched in time or compressed to fit a specified scene length. The editor can also edit an audio file by shifting the pitch of the audio file and/or other elements of the audio files. The editor may make a final selection of the audio file at 86 after the editor has selected, and if necessary edited the file.

The invention is flexible and may also be used to facilitate entry into work agreements between music sellers and music buyers on line through the service provider. For example, a buyer may review the collected work of a particular composer or publisher. If modifications are required beyond normal editing, a music buyer may submit a request for proposal to a music seller via the network through the service provider 50 to a selected music seller. The seller may then accept or reject the request for proposal. If the request for proposal is accepted, the service provider will generate a project code and will assign that project code to any submissions uploaded by the music seller. The buyer may also be issued a project code and password if access to the files is restricted. The music seller may submit a musical work in the form of a digital audio file to the music buyer. Digital audio files may be transmitted to the service provider's server or may be maintained on the composer or publisher's server provided that the URL of the digital audio file is made available to the music buyer through the service provider.

Music buyers may enter search criteria and perform a search by project name using a web browser or the application. The database search application will retrieve digital audio files associated with the project name.

A music buyer may request revisions, accept, or reject submissions pursuant to the request for proposal. The music buyers and sellers may communicate via e-mail or instant message through the service provider. If a composer or publisher's submission is rejected, their password may be deactivated to prevent further communication with the music buyer or further submission of digital audio files if the music buyer is no longer interested. If the seller's submission is accepted, the music buyer may indicate a desire to purchase the digital audio file which is facilitated through the service provider 50 using an on-line credit card by placing the charge on account, or by applying other purchasing methods.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A network-based system for centrally sampling distributed multimedia, the system comprising:
a plurality of distributed multimedia source computers;
a multimedia warehouse configured to receive and archive multimedia files uploaded from the plurality of distributed multimedia source computers; and
at least one multimedia sampling computer configured to download one or more multimedia files archived in the multimedia warehouse and play the downloaded multimedia file(s) in synchronization with a project file.

2. The system of claim 1 wherein the multimedia warehouse comprises a network server computer system in operable communication with at least one database.

3. The system of claim 1 wherein the multimedia files are selected from a group consisting of audio files, video files, combined audio and video files and picture files.

4. The system of claim 1 wherein the project file is selected from a group consisting of audio files, video files, combined audio and video files and picture files.

5. The system of claim 1 wherein the at least one multimedia sampling computer is additionally configured to search the multimedia warehouse for multimedia files that best-match user-defined search criteria.

6. The system of claim 5 wherein the search criteria comprise file type, file format, composition name, company name, composer name, project name, tempo and description.

7. The system of claim 6 wherein tempo is defined by a tap tempo calculator peripheral device operably connected to the at least one multimedia sampling computer.

8. The system of claim 1 wherein the at least one multimedia sampling computer is additionally configured to edit playback attributes of the downloaded multimedia file(s).

9. The system of claim 1 wherein the distributed multimedia source computers, the multimedia warehouse and the multimedia sampling computer(s) are configured to host preview, purchasing, or licensing of multimedia files.

10. The system of claim 1 wherein the distributed multimedia source computers, the multimedia warehouse and the multimedia sampling computer(s) are configured to host online communication between users of the multimedia source computers and users of the multimedia sampling computer(s).

11. The system of claim 1 wherein the distributed multimedia source computers, the multimedia warehouse and the multimedia sampling computer(s) are configured to monitor version control for multimedia file revisions.

12. The system of claim 1 wherein the multimedia sampling computer has an e-mail system for inviting selected multimedia source computers to have access to the project file.

13. The system of claim 1 wherein the multimedia warehouse has a local server that queries a web server and retrieves new multimedia files for the multimedia warehouse, the sampling computer having an application that automatically associates an identified user with the local server, the sampling computer upon recognizing the identified user and determining that the local server is available, selects files from the local server, the sampling computer upon recognizing the identified user and determining that the local server is not available, obtains files from a web server.

14. A network-based method for marketing multimedia, the method comprising:
receiving multimedia files from a plurality of distributed multimedia providers into an online multimedia warehouse;
providing the multimedia files within the online multimedia warehouse to distributed multimedia consumers for download wherein the multimedia consumers sample downloaded multimedia files in synchronization with a project file; and
selling or licensing the downloaded multimedia file to the multimedia consumer.

15. The method of claim 14 wherein the multimedia files are selected from a group consisting of audio files, video files, combined audio and video files and picture files.

16. The method of claim 14 wherein the project file is selected from a group consisting of audio files, video files, combined audio and video files and picture files.

17. The method of claim 14 additionally comprising searching the multimedia warehouse for multimedia files that best-match user-defined search criteria.

18. The method of claim 14 additionally comprising editing playback attributes of the downloaded multimedia files.

19. The method of claim 14 additionally comprising presenting a multimedia consumer's request for a custom multimedia file to a multimedia provider.

20. The method of claim 19 additionally comprising accepting or rejecting the multimedia consumer's request for the custom multimedia file.

21. The method of claim 14 additionally comprising presenting a multimedia consumer's request for a revision to a multimedia file to a multimedia provider.

22. A computer-readable storage medium containing computer executable code for instructing one or more computers to:
receive input defining multimedia file search criteria;
search one or more databases for multimedia files that best-match the search criteria;
present output containing a selectable listing of the multimedia files that best-match the search criteria to a user; and
receive user input selecting one or more of the presented multimedia files; and
present output playing the selected multimedia file(s) in synchronization with a project file.

23. The computer-readable storage medium of claim 22 wherein the computer executable code additionally instructs the one or more computers to receive user input selecting one or more multimedia files to purchase or license.

24. The computer-readable storage medium of claim 22 wherein the computer executable code additionally instructs the one or more computers to edit playback attributes of the selected multimedia file(s).
